(19) United States
(12) Patent Application Publication
(10) Pub. No.: US 2016/0373014 A1
(43) Pub. Date: Dec. 22, 2016

(54) SWITCHED-MODE CONVERTER WITH SIGNAL TRANSMISSION FROM SECONDARY SIDE TO PRIMARY SIDE

(71) Applicant: Infineon Technologies Austria AG, Villach (AT)

(72) Inventor: Bernd Pflaum, Unterhaching (DE)

(21) Appl. No.: 15/183,071

(22) Filed: Jun. 15, 2016

(30) Foreign Application Priority Data
Jun. 17, 2015 (DE) 10 2015 109 692.7

(51) Int. Cl. H02M 3/335; H02M 1/08

(52) U.S. Cl. CPC H02M 3/33523; H02M 1/08

(57) ABSTRACT

A circuit for a switched-mode power supply is described. According to at least one configuration, the circuit comprises a switched-mode converter having a transformer for DC isolation between a primary side and a secondary side of the switched-mode converter, wherein the switched-mode converter is designed to convert an input voltage supplied to the switched-mode converter into an output voltage as stipulated by a switching signal. Arranged on the primary side of the switched-mode converter is a control circuit that is designed to produce the switching signal for the switched-mode converter. The circuit furthermore comprises a DC isolating transmission channel that is used to transmit a modulated feedback signal to the control circuit on the primary side. Arranged on the secondary side of the switched-mode converter is an integrated circuit that has an encoding circuit and a modulator circuit. The encoding circuit is supplied with two or more feedback signals, and the encoding circuit produces an encoded signal from the feedback signals. The modulator circuit produces the modulated feedback signal as stipulated by the encoded signal.

### RELATED APPLICATIONS

This application is related to and claims priority to German filed Patent Application Number DE 10 2015 109692.7, entitled “SWITCHED-MODE CONVERTER WITH SIGNAL TRANSMISSION FROM SECONDARY SIDE TO PRIMARY SIDE,” filed on Jun. 17, 2015, the entire teachings of which are incorporated herein by this reference.

### BACKGROUND

Many portable electronic appliances, such as cell phones, tablet and laptop computers, MP3 players, etc., are supplied with power by means of rechargeable batteries. Many appliances have a universal serial port (USB) interface to which a charger for charging the battery can be connected. The USB standard defines two charging modes. In one mode, the USB port of the appliance is referred to as a “dedicated charging port” (DCP), and in a second mode, it is referred to as a “standard downstream port” (SDP). A DCP can be used to effect fast charging. So that the charger can switch to a fast charging mode, the portable appliance must communicate to the charger whether fast charging is supported or desired. In some cases, it may also be necessary to transmit information from the charger to the portable appliance. In this case, the use of a USB port for connecting a charger can be understood only as an illustrative example. It goes without saying that any other connections can be used.

### BRIEF DESCRIPTION OF EMBODIMENTS

In more complex switched-mode power supplies, multiple signals are transmitted from a secondary side circuit to a primary side controller, which entails corresponding complexity for the DC isolation. Depending on the application, there may be e.g. a multiplicity of optocouplers required and the integrated circuit (IC) in which the secondary side electronics are integrated requires a multiplicity of output pins for the data transmission to the primary side controller. The object on which embodiments herein are based can thus be considered to be that of providing a switched-mode power supply circuit that requires fewer output pins for the secondary-side IC and gives rise to lower outlay for the DC isolation. This object is achieved by the circuit according to claim 1, and the method according to claim 7. Various exemplary embodiments and further developments are covered by the dependent claims.

A circuit for a switched-mode power supply is described. According to one exemplary embodiment herein, the circuit comprises a switched-mode converter having a transformer for DC isolation between a primary side circuit and a secondary side circuit of the switched-mode converter, wherein the switched-mode converter is designed to convert an input voltage supplied to the switched-mode converter into an output voltage as stipulated by a switching signal. Arranged on a primary side of the switched-mode converter is a control circuit that is designed to produce the switching signal for the switched-mode converter. The circuit furthermore comprises a DC isolating transmission channel that is used to transmit a modulated feedback signal to the control circuit on the primary side. Arranged on the secondary side circuit of the switched-mode converter is an integrated circuit that has an encoding circuit and a modulator circuit. The encoding circuit is supplied with two or more feedback signals, and the encoding circuit produces an encoded signal from the feedback signals. The modulator circuit modulates the encoded signal in order to produce the aforementioned modulated feedback signal.

Embodiments herein are explained in more detail below on the basis of the examples illustrated in the figures. The illustrations are not necessarily to scale and the embodiments herein are not limited just to the aspects shown. Rather, a point is made of illustrating the principles on which embodiments herein are based. Identical reference symbols denote corresponding parts or signals.

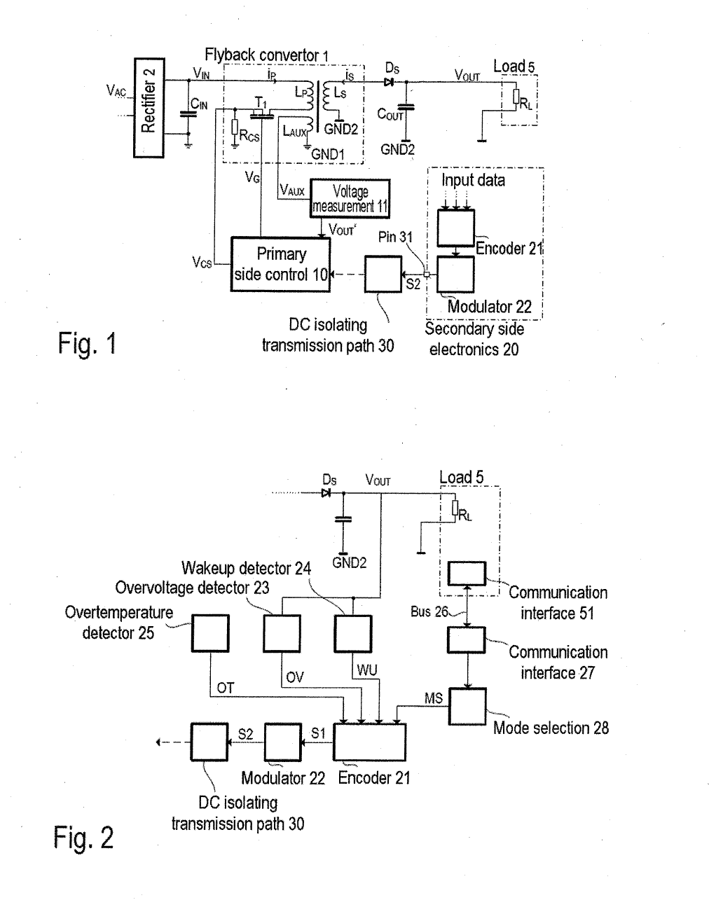

FIG. 1 shows an example of a circuit with a flyback converter and a primary side controller that receives data from the secondary side circuit that are needed for controlling the switched mode of the flyback converter according to embodiments herein.

FIG. 2 shows the secondary side electronics of the circuit from FIG. 1 with more details according to embodiments herein.

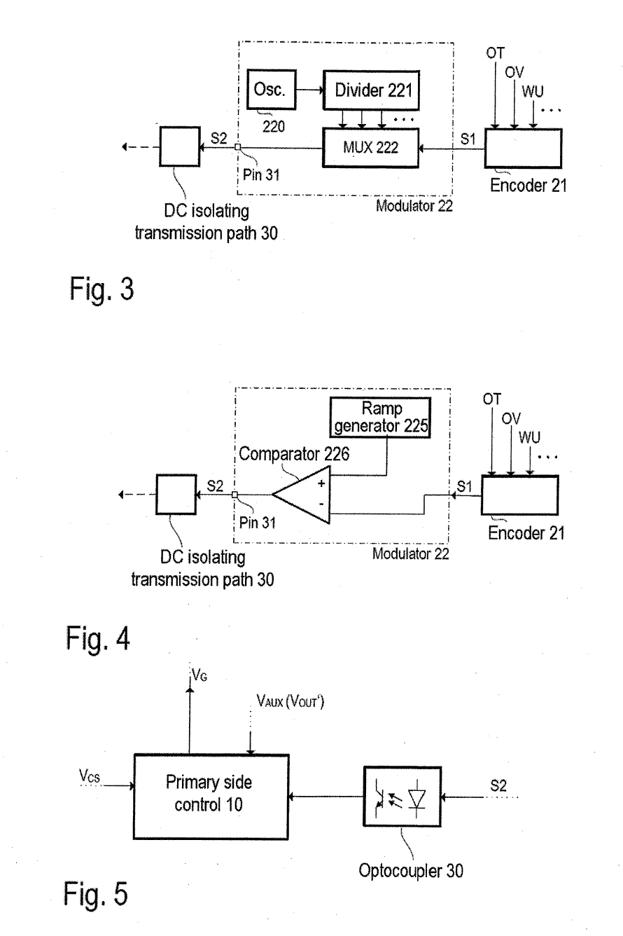

FIG. 3 shows an example of the signal encoding and modulation for the data transmission from the secondary side circuit to the primary side controller using a DC isolating transmission path according to embodiments herein.

FIG. 4 shows a further example of the signal encoding and modulation for the data transmission from the secondary side circuit to the primary side controller using a DC isolating transmission path according to embodiments herein.

FIG. 5 shows an exemplary implementation of the DC isolating transmission path from one of FIGS. 1 to 4 with an optocoupler according to embodiments herein.

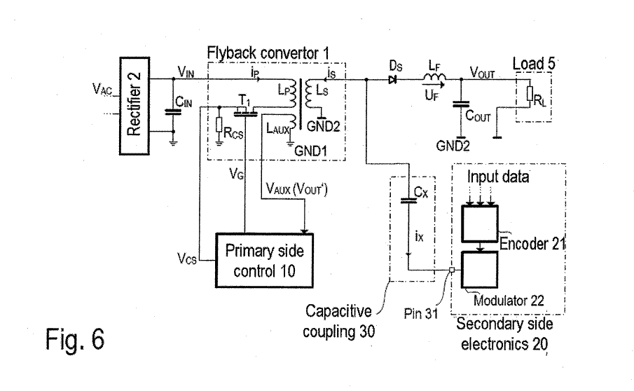

FIG. 6 shows a further exemplary implementation of the DC isolating transmission path from one of FIGS. 1 to 4 with a capacitive coupling to the secondary of the flyback converter according to embodiments herein.

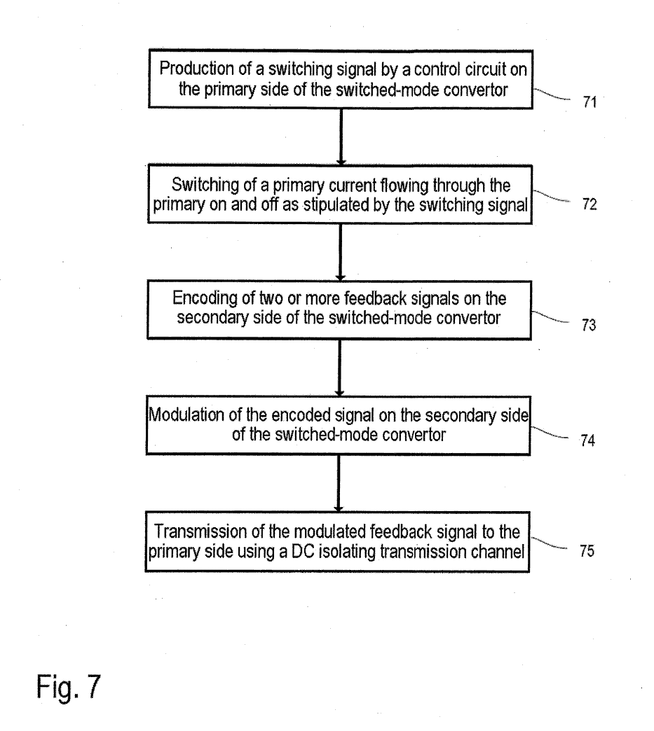

FIG. 7 is a flowchart to illustrate an example of a method for controlling the circuit from FIG. 1 according to embodiments herein.

In the present description of the exemplary embodiments, the exemplary application described for a switched-mode power supply is a charger for a portable appliance (such e.g. a cell phone, a laptop or a tablet PC). However, embodiments herein are not limited to chargers, and the switched-mode power supplies described herein can also be used in many other applications. The switched-mode converter used in the exemplary embodiments described herein is a flyback converter. Embodiments herein are not limited to the use of flyback converters, however, and instead it is also possible to use any other switched-mode converter topology with DC isolation between primary and secondary sides.

The switched-mode power supply circuit shown in FIG. 1 comprises a flyback converter 1 as the switched-mode converter. The flyback converter 1 has a transformer for DC isolation between the primary side circuit and the secondary side circuit of the switched-mode converter. In the present example, the transformer 1 has a primary winding L_{P} (having N_{P} turns) and a secondary winding L_{S} (having N_{S} turns). Optionally, an auxiliary winding L_{AUX} (having N_{AUX} turns) may be provided, from which an auxiliary voltage V_{AUX} can be tapped off. The purpose of the auxiliary winding L_{AUX} and the use of the auxiliary voltage V_{AUX} are explained later on. A semiconductor switch T₁ (e.g. an MOS transistor) is connected in series with the primary winding L_{P}. The semiconductor switch T₁ can therefore switch a primary current flowing through the primary winding L_{P} ON and OFF as stipulated by a switching signal. When the semiconductor switch T₁ is on, the input voltage V_{IN} supplied to the switched-mode converter is essentially applied to the primary winding L_{P}. A small portion of the input voltage drops across the (switched-on) semiconductor switch T₁ and across a current measuring resistor R_{CS} (if present) that may be connected in series with the primary winding.

The aforementioned current measuring resistor R_{CS} is just one example of a current measuring circuit for measuring the primary current i_{P} through the primary winding L_{P}. In this case, a current measurement signal V_{CS} that represents the primary current i_{P} can be tapped off from the current measuring resistor R_{CS}. However, it is also possible to use other approaches for current measurement, for example, a semiconductor switch with integrated current measurement function (MOSFETs with an integrated SenseFET). In the present example, the input voltage V_{IN} supplied to the flyback converter 1 is made available by a rectifier 2 that produces the input voltage V_{IN} from an AC voltage V_{AC} (e.g. from the grid). To smooth the input voltage V_{IN}, a capacitor C_{IN} may be connected to the output of the rectifier 2 (and therefore to the input of the flyback converter 2).

In general, switched-mode converters are designed to convert an input voltage supplied to the switched-mode converter into an output voltage as stipulated by a switching signal. In the present example, the input voltage V_{IN} of the flyback converter 1 drops across the series circuit comprising primary winding L_{P}, semiconductor switch T₁ and current measuring resistor R_{CS}. In the case of a MOSFET, the switching signal is either a gate voltage V_{G} supplied to the MOSFET or a gate current. When the semiconductor switch T₁ is switched on, the primary current i_{P} rises in a ramp-like manner and the energy E stored in the primary winding L_{P} rises. During this phase of “charging” of the primary winding L_{P}, the secondary current is to the secondary L_{S} is zero, since a diode D_{S} connected in series with the secondary winding L_{S} is reversed biased. When the primary current i_{P} is switched off, the diode D_{S} connected in series with the secondary winding L_{S} is forward biased and the secondary current rises abruptly to a peak value and drops in a ramp-like manner, while the secondary current (via the diode D_{S}) charges an output capacitor C_{OUT}. The output capacitor smooths the resulting output voltage V_{OUT} and is connected in parallel with the series circuit comprising secondary winding L_{S} and diode D_{S}. The output voltage V_{OUT} is supplied to a load 5. By way of example, the load 5 may be a portable electrical or electronic appliance that contains a battery that is to be charged. The ground node on the secondary side is denoted by GND2. The ground node on the primary side circuit (such as a combination of circuitry including Rcs, T1, controller 10, voltage monitor 11, etc.), which is DC isolated from the ground node GND2, is denoted by GND1.

Various methods are known for determining the switch-on times and the switch-off times for the semiconductor switches T₁. The switching times are generally dependent on the mode of operation of the switched-mode converter and on the strategy used to regulate the output voltage (or the output current). The Continuous-Current-Mode (CCM) and Discontinuous-Current-Mode (DCM) modes of operation and (as a special case of DCM) the quasi-resonant mode (QRM) are known per se and are not explained further herein. The control strategy referred to as Current-Mode-Control involves the semiconductor switch T₁ being switched off at the time at which the primary current has reached a settable primary current peak value, i_{PP}. The output voltage V_{OUT} is then set by means of variation of primary current peak value i_{PP}. Another known control strategy is Voltage-Mode-Control.

The functionality for determining the correct switching times of the semiconductor switch T₁ is implemented in the control circuit 10 (referred to as primary side controller in FIG. 1). The control circuit 10 is arranged on the primary side of the switched-mode converter, and a task of the control circuit 10 is to produce the switching signal (e.g. gate voltage V_{G}) for the semiconductor switch T₁. In this connection, “arranged on the primary side of the switched-mode converter” means that the circuit in question is DC coupled to the primary side, but DC isolated from the secondary side circuit (such as secondary side electronics, Cout, load, etc.) of the switched-mode converter. Depending on the mode of operation (e.g. CCM, DCM, QRM) and the control strategy used (e.g. regulation of the output voltage using Current-Mode-Control), the switching signal V_{G} is produced on the basis of various control parameters and/or feedback signals. In this case, a feedback signal is understood to mean any signal (regardless of the origin thereof) that includes information that is used by the control circuit 10 to control the switching response of the flyback converter 1.

To regulate the output voltage V_{OUT}, the control circuit 10 uses a measurement signal that represents the output voltage and also a target value for the output voltage. The control circuit 10 is operable to produce the switching signal for the flyback converter 1 such that the output voltage V_{OUT} approximately corresponds to the target value. The remaining difference between output voltage and target value is referred to as an error signal. A measurement signal representing the output voltage V_{OUT} can be obtained very easily on the secondary side circuit, since the output voltage can be tapped off directly from the output of the switched-mode converter. In the example from FIG. 1, the output of the switched-mode converter is the common circuit node of diode D_{S} and capacitor C_{OUT}. A measurement signal representing the output voltage V_{OUT} can also be provided on the primary side circuit of the switched-mode converter, however. By way of example, measured values representing the output voltage V_{OUT} can be derived from the auxiliary voltage V_{AUX} that is induced in the auxiliary winding L_{AUX}. This voltage measurement can be accomplished by the voltage measuring circuit 11, which is usually integrated in the control circuit 10. For the sake of better illustration, the voltage measuring circuit 11 is shown separately from the control unit 10 in FIG. 1, however. The voltage measuring circuit 11 can be configured to measure the auxiliary voltage V_{AUX} in any suitable manner. By way of example, in the DCM, the auxiliary voltage V_{AUX} is proportional to the output voltage (V_{AUX}=V_{OUT}·N_{AUX}/N_{S}), and can then be used once per switching period as a measured value for the output voltage V_{OUT}, at any time at which the secondary current becomes zero.

Other feedback signals used by the control circuit 10 on the primary side circuit of the switched-mode converter are available only on the secondary side circuit. Various examples are shown in FIG. 2, which shows a portion of the secondary side circuit of the switched-mode converter from FIG. 1 in detail. By way of example, arranged on the secondary side circuit there may be an overvoltage section circuit (see FIG. 2, overvoltage detector 23) that is designed to detect an overvoltage at the output of the flyback converter 1 (criterion for the detection of an overvoltage: V_{OUT}>V_{TH}, where V_{TH} is a prescribable threshold value) and to signal the result of the detection, i.e. to produce a (binary) overvoltage signal OV as a feedback signal. As a further feedback signal, which is available only on the secondary side circuit, a wakeup circuit (see FIG. 2, wakeup detector 24) can produce a wakeup signal, WU, that signals that the switched-mode converter needs to change from a sleep mode to the normal mode because the connected load 5 requires its rated power. By way of example, a wakeup signal WU is produced when the output voltage drops below a defined threshold value. Very rapid detection of a “wakeup event” may also be a result of evaluation of the current gradient di_{S}/dt of the secondary current is. To this end, the voltage across a coil L_{F} that is connected in series with the diode D_{S} can be evaluated (e.g. see FIG. 6). The voltage U_{F} across the coil is proportional to the aforementioned current gradient. If the current gradient exceeds a defined threshold value, this is indicated by the wakeup signal WU. Instead of a coil, the inductance of the line may also be sufficient to obtain a voltage signal representing the current gradient. Alternatively, a resistor can also be used. The voltage drop across the resistor is then proportional to the current (rather than to the current gradient di_{S}/dt), but the gradient can be formed by suitable electronic circuits. An overtemperature signal OT can also be provided on the secondary side circuit as a feedback signal (see FIG. 2, overtemperature detector 25). The overtemperature detector 25 comprises e.g. a temperature sensor producing a measurement signal that represents the temperature and that is compared with a temperature threshold value. When the threshold value is exceeded, the overtemperature signal OT indicates an overtemperature. Finally, a mode select signal MS can be provided on the secondary side of the flyback converter 1 as a feedback signal. By way of example, the mode select signal MS can be produced by a mode selection circuit 28 that is designed to use a communication interface 27 to receive commands from the load 5 (or another external unit) via a bus (e.g. Universal Serial Bus, USB) or a point-to-point connection. Depending on the information contained in the received commands, a feedback signal is then produced. In the present example, the load 5 likewise has a communication interface 51, which is connected to the communication interface 27 via one or more bus lines 26 (e.g. via a USB cable). The information contained in a command sent by the load 5 and received via the communication interface 27 can relate e.g. to the level of the output voltage V_{OUT}. By way of example, the load 5 can use the bus connection to request a particular output voltage from the switched-mode power supply. If the switched-mode power supply is used e.g. in a charger, the load 5 (e.g. the appliance with the battery to be charged) can request a fast charge. The mode selection circuit 28 then receives the relevant request command via the bus line(s) 26 and produces a corresponding mode select signal MS. When e.g. a fast charge is requested by the load, the mode select signal MS can signal a fast charge mode in which the flyback converter 1 needs to produce a higher output voltage V_{OUT} (e.g. 12 V or 9 V instead of 5 V).

The feedback signals OT, OV, WU, MS produced feedback on the secondary side circuit need to be supplied to the control circuit 10 (the primary side controller) in order to allow the latter to take account of the feedback signals when controlling the switched mode of the flyback converter 1. In this case, the feedback signals need to be transmitted from the secondary side circuit to the primary side circuit via a DC isolation, i.e. using a DC isolating signal path 30 (that comprises e.g. an optocoupler). The overvoltage detector 23, the wakeup detector 24, the overtemperature detector 25 and the mode selection circuit 28 and further electronic components arranged on the secondary side circuit of the flyback converter 1 may be contained in an integrated circuit (IC) (i.e. in a semiconductor chip or in a chip package, referred to as secondary side electronics 20 in FIG. 1). Usually, the IC on the secondary side circuit has a separate pin for each of the feedback signals that are to be transmitted, and each feedback signal is transmitted to the primary side controller via a separate DC isolating signal path. For a larger quantity of feedback signals, this results in a corresponding quantity of optocouplers and a corresponding magnitude for the chip package (on account of the number of pins). In order to reduce the number of pins required by the secondary side IC and in order to reduce the complexity of the DC isolation, the IC 20 arranged on the secondary side circuit can contain an encoding circuit and a modulator circuit (see FIGS. 1 and 2, encoder 21, modulator 22).

The encoder 21 is supplied with two or more of the feedback signals (e.g. signals OT, OV, WU, MS, etc.), and the encoder 21 produces from the feedback signals an encoded signal S1, which is supplied to the modulator 22. The modulator 22 is designed to modulate the encoded signal S1 on the basis of a prescribed modulation scheme (e.g. frequency shift key (FSK), pulse width modulation (PWM), etc.), as result of which a modulated feedback signal S2 is produced. The modulated feedback signal S2 is transmitted to the control unit 10 via a DC isolating signal path 30. The described encoding of multiple feedback signals to produce an encoded (e.g. digital) signal and the subsequent modulation allow the complexity of the IC 20 arranged on the secondary side and of the DC isolation to be reduced. It is then only necessary to transmit a (single) modulated feedback signal S2 to the control unit 10 via a DC isolation. The secondary side IC 20 then requires only one pin 31 in order to provide the modulated feedback signal S2 externally. The DC isolation can be designed in a relatively simple manner in this case and then requires only a single optocoupler, for example. The encoding means that the information contained in the feedback signals OT, OV, WU, MS, etc. is also contained in the encoded signal S1 and therefore also in the modulated feedback signal S2. This information can be reconstructed again in the control unit 10 by means of suitable demodulation and decoding and processed further.

FIGS. 3 and 4 show different exemplary embodiments of the modulator 22. In the example shown in FIG. 3, the encoded signal S1 is modulated by means of frequency shift keying (FSK). To this end, the modulator 21 comprises an oscillator 220 and a frequency divider 221, which outputs a series of carrier signals at different frequencies, f₁, f₂, f₃, etc., which are supplied to a multiplexer 222 (i.e. to the signal inputs thereof). Which of the carrier signals is connected to the output of the multiplexer 222 is dependent on the encoded signal S1 that is supplied to a control input of the multiplexer 222. The signal at the output of the multiplexer 222 is output as a modulated feedback signal S2. The information transmitted by the modulated feedback signal S2 is embedded in the frequency of the signal S2. By way of example, it is thus possible for a frequency f₁ to represent an overvoltage, for a frequency f₂ to represent a fast charge mode, etc. In the example shown in FIG. 3, the encoder 21 may be of relatively simple design; in this case, the encoder 21 produces a multibit digital signal that represents a digital value that includes the information for all of the feedback signals that are to be encoded. A multibit digital signal is thus a series of digital words that each have two or more bits. The encoded signal S1 may be e.g. a 2-bit digital signal whose value (00, 01, 10 or 11) indicates which of the binary feedback signals (OT, OV, WU, MS, etc) has a high level. In this case, e.g. OT=1 gives rise to an encoded signal S1=00, OV=1 gives rise to an encoded signal S1=01, WU=1 gives rise to an encoded signal S1=10 and MS=1 gives rise to an encoded signal S1=11. If multiple feedback signals have a high level, then these can be encoded in succession (i.e. using the time-division multiplexing method, i.e. the series 00, 11 for OT=1 and MS=1). Other options for encoding are naturally likewise possible. In the simplest case, the (binary) states of the four feedback signals can be output by the encoder 21 simply as a 4-bit digital signal. In this case, e.g. the 4-bit word 0101 represents the feedback signals OT=0, OV=1, WU=0, MS=1.

In FIG. 4, the encoded signal S1 is subjected to pulse width modulation in order to obtain the modulated feedback signal S2. In this case, the encoder 21 can have a digital/analog converter, for example, which—as an encoder signal S1—outputs an analog signal whose level represents the state of the feedback signals OT, OV, WU, MS, etc. In this case, the encoded signal S1 represents the duty cycle of the pulse width modulation performed by the modulator 22 and contains the information from all of the feedback signals that are to be encoded. The modulator 22 then produces a pulse width modulated signal having a duty cycle that is prescribed by the encoded signal S1. To this end, the modulator 22 has a ramp generator 225 that outputs a periodically ramp-like pulses (saw tooth signal). The output signal from the ramp generator 225 and the analog encoded signal S1 are supplied to a comparator 226 that is contained in a modulator 22. The comparator 226 compares the output signal from the ramp generator 225 with the signal S1 and provides, at the output, a modulated signal that has e.g. a low level while the level of the saw tooth signal (output signal from the ramp generator 225) is lower than the level of the signal S1. The output signal from the comparator 226 is a pulse width modulated signal that is provided as a modulated feedback signal at the output of the modulator (e.g. via the pin 31). By way of example, the ramp generator 225 can produce ramps rising linearly from 0 to 5V, the encoded signal S1 likewise being able to assume values between OV and 5V. In this example, a signal S1 of 4V would then bring about a duty cycle of 80%. In this respect, the encoded signal S1 sets the duty cycle of the pulse width modulation. The encoded signal thus represents the duty cycle of the pulse width modulation. As already described in FIGS. 1 and 2, the modulated feedback signal S2 is transmitted via the DC isolating signal path 30 to the control unit 10, which can reconstruct (by means of demodulation and decoding) the information contained in the modulated feedback signal.

FIG. 5 5 shows an example of implementation of the DC isolating signal path 30, as is shown e.g. in FIGS. 1 and 2. According to the present example, the DC isolating signal path 30 essentially has an optocoupler. The optocoupler is supplied with the modulated signal S2 (output signal from the modulator 22, see FIG. 2 2), and on the basis of the modulation method used, the optocoupler 30 may be of very simple design (e.g. by means of a light emitting diode and a phototransistor, with only the states “on” and “off” being transmitted). FIG. 5 also shows the control unit 10. Unlike in FIG. 1, the voltage measuring unit 11 is integrated in the control unit 10 and the auxiliary voltage V_{AUX} is supplied directly to the control unit 10.

FIG. 6 shows an alternative embodiment of the DC isolating signal path 30. According to FIG. 6, the transformer of the flyback converter 1 is used for the DC isolation. In this case, the modulator 22 provides a modulated current signal at its output, which current signal is supplied to the secondary winding L_{S} of the transformer of the flyback converter 1 via a capacitor C_{X}. That is to say that the (current) output of the modulator 22 is coupled to a first connection of the secondary winding L_{S} via the capacitor C_{X}, while the second connection of the secondary winding L_{S} is connected to ground GND2. In the present case, the modulated feedback signal S2 is thus the current i_{X}, which is supplied via the capacitor C_{X} in the secondary and is overlayed on the secondary current therein. The thus prompted change in the secondary current by the current i_{X} results in a corresponding change in the primary current i_{P}, which change can be measured directly by the control unit 10 (current measurement signal V_{CS}). In order to achieve transmission with as little interference as possible, it is possible—when the switched-mode converter is operated in discontinuous current mode (DCM)—for the encoded signal to be modulated such that the information contained in the modulated feedback signal is transmitted after the (induced) current that the secondary of the transformer has dropped to zero. Even in burst mode, the secondary current falls to zero and remains at zero for a particular time; the switched mode of the semiconductor switch T₁ is interrupted and the semiconductor switch T₁ remains off between the bursts. Even in this case, the feedback signal can be transmitted in the time intervals between the bursts. DCM and burst mode are known per se in the field of switched-mode converters and are therefore not explained further herein. In the example from FIG. 6, there is also an (optional) inductance L_{F} shown in series with the secondary winding L_{S} and the diode D_{S}, which inductance is used inter alia to filter high frequency interference. As explained earlier on, the voltage U_{F} that drops with the aid of this coil L_{F} (and that is proportional to the gradient di_{S}/dt of the secondary current) can a wakeup event to be detected. Such an event is detected e.g. when the voltage U_{F} and hence the current gradient exceed a predefined threshold value.

FIG. 7 is a flowchart to illustrate an example of a method for controlling a switched-mode converter as has been explained e.g. with reference to FIGS. 1 to 6. On the basis of the method presented, a control circuit 10 (cf. e.g. FIG. 1, primary side control 10) on the primary side circuit of the switched-mode converter is used to produce a switching signal V_{G} (FIG. 7, step 71). As stipulated by the switching signal V_{G}, the primary current i_{P} flowing through the primary L_{P} is switched on and off; this switched mode converts the input voltage V_{IN} into the output voltage V_{OUT} (FIG. 7, step 72). The method comprises production of an encoded signal (see FIGS. 3 and 4, signal S1) by means of encoding of two or more feedback signals on the secondary side circuit of the switched-mode converter (FIG. 7, step 73). By modulating the encoded signal S1 on the secondary side circuit of the switched-mode converter, a single modulated feedback signal (see FIGS. 3 and 4, signal S2) is produced (FIG. 7, step 74). The modulated feedback signal S2 is transmitted to the control circuit 10 on the primary side circuit using a DC isolating transmission channel 30 (FIG. 7, step 75).

In the description above, the embodiments herein have been described on the basis of specific exemplary embodiments. The structural features explained in connection with the examples presented perform a particular function that has likewise been described, if not readily identifiable to a person skilled in the art. It goes without saying that the structural features can be replaced by other features if they perform the same function. Such modifications are likewise covered by the exemplary embodiments described. By way of example, certain circuit components can be implemented both in digital technology and in analog technology. Physical and logical signal levels can differ from one another. Quite generally, features that have been described with reference to a specific exemplary embodiment can also be used in other exemplary embodiments unless stated otherwise.

### FURTHER EMBODIMENTS

Additional embodiments herein include any combination of one or more of the techniques as described herein.

In one embodiment, a switched-mode power supply circuit includes: a switched-mode converter having a transformer for DC isolation between a primary side circuit and a secondary side circuit of the switched-mode converter, wherein the switched-mode converter is designed to convert an input voltage supplied to the switched-mode converter into an output voltage as stipulated by a switching signal; a control circuit, arranged on the primary side circuit of the switched-mode converter, that is designed to produce the switching signal for the switched-mode converter; a DC isolating transmission channel that is used to transmit a modulated feedback signal to the control circuit on the primary side circuit; and an integrated circuit, arranged on the secondary side circuit of the switched-mode converter, that comprises an encoding circuit and a modulator circuit, wherein the encoding circuit has two or more feedback signals supplied to it and the encoding circuit is designed to produce an encoded signal from the feedback signals, and wherein a modulator circuit is designed to modulate the encoded signal, as a result of which the modulated feedback signal is produced.

In accordance with further embodiments, all of the information contained in the two or more feedback signals is transmitted with the modulated feedback signal.

In accordance with further embodiments, only a single DC isolating transmission channel is used for a transmission from the secondary side circuit to the primary side circuit of the switched-mode converter.

In accordance with further embodiments, the transformer has a primary and a semiconductor switch coupled thereto, wherein the semiconductor switch is designed to switch a current flowing through the primary on and off as stipulated by the switching signal.

In accordance with further embodiments, all of the circuit components arranged on the secondary side circuit of the switched-mode converter are DC isolated from the primary.

In accordance with further embodiments, one of the two or more feedback signals is produced by an overvoltage detector circuit, wherein the feedback signal produced by the overvoltage detector circuit indicates whether or not the output voltage exceeds a prescribable threshold value.

In accordance with further embodiments, one of the two or more feedback signals is produced by a mode selection circuit that is operable to receive commands from an external unit and to take the information contained in the received commands as a basis for producing a feedback signal.

In accordance with further embodiments, the external unit is the load connected to the output voltage and in which the information contained in the received command relates to the level of the output voltage.

In accordance with further embodiments, one of the two or more feedback signals is a wakeup signal that is produced by a wakeup detector circuit that is designed to take the output voltage as a basis for producing the wakeup signal.

In accordance with further embodiments, one of the two or more feedback signals is an overtemperature signal that is produced by an overtemperature detector circuit that is operable to signal an overtemperature.

In accordance with further embodiments, the modulator circuit is operable to modulate the encoded signal by means of frequency shift keying (FSK).

In accordance with further embodiments, the encoding circuit produces a multibit digital signal as the encoded signal, the multibit digital signal includes the information contained in the two or more feedback signals, and wherein the modulator circuit changes over a frequency of the modulated feedback signal as stipulated by the multibit digital signal.

In accordance with further embodiments, the modulator circuit is operable to modulate the encoded signal by means of pulse width modulation (FSK).

In accordance with further embodiments, the encoding circuit produces an analog or a digital duty cycle signal as the encoded signal, the digital duty cycle signal includes the information contained in the two or more feedback signals, and wherein the modulator circuit is operable to adjust a duty cycle of the modulated feedback signal as stipulated by the duty cycle signal.

In accordance with further embodiments, the DC isolating transmission channel comprises an optocoupler used to transmit the modulated feedback signal from the secondary side circuit to the primary side circuit of the switched-mode converter.

In accordance with further embodiments, the DC isolating transmission channel comprises a capacitor coupled to the secondary of the transformer, so that the modulated feedback signal is transmitted to the primary side circuit via the transformer.

In accordance with further embodiments, the modulator circuit is operable to modulate the encoded signal such that the modulated feedback signal is then used to transmit after the current through a secondary of the transformer has dropped to zero.

Further embodiments herein include method for controlling a switched-mode power supply circuit that has a transformer having a primary and a secondary for the purpose of isolating primary side circuit and secondary side circuit; the method comprising the following: program a switching signal by a control circuit on the primary side circuit of the switched-mode converter; switching of a primary current flowing through the primary on and off as stipulated by the switching signal in order to convert an input voltage into an output voltage; producing an encoded signal by encoding two or more feedback signals on the secondary side circuit of the switched-mode converter; producing a single modulated feedback signal by modulating the encoded signal on the secondary side circuit of the switched-mode converter; transmitting of the modulated feedback signal to the control circuit on the primary side circuit using a DC isolating transmission channel.

In accordance with further embodiments, the modulation of the encoded signal prompts pulse width modulation or frequency shift keying (FSK).

In accordance with further embodiments, the modulated feedback signal is transmitted using an optocoupler.

In accordance with further embodiments, the modulated feedback signal is a current signal that is supplied to the primary by means of a capacitor and is transmitted to the primary side circuit of the switched-mode converter by means of the transformer.

I claim:

1. A switched-mode power supply circuit that has the following:
a switched-mode converter having a transformer for DC isolation between a primary side circuit and a secondary side circuit of the switched-mode converter, the switched-mode converter operable to convert an input voltage supplied to the switched-mode converter into an output voltage as stipulated by a switching signal;
a control circuit, arranged on the primary side circuit of the switched-mode converter, the control circuit operable to produce the switching signal for the switched-mode converter;
a DC isolating transmission channel operable to transmit a modulated feedback signal to the control circuit on the primary side circuit; and
an integrated circuit, arranged on the secondary side circuit of the switched-mode converter, that comprises an encoding circuit and a modulator circuit, wherein the encoding circuit has two or more feedback signals supplied to it and the encoding circuit is operable to produce an encoded signal from the feedback signals, and wherein a modulator circuit is operable to modulate the encoded signal, as a result of which the modulated feedback signal is produced.

2. The switched-mode power supply circuit as in claim 1,
wherein all of the information contained in the two or more feedback signals is transmitted with the modulated feedback signal.

3. The switched-mode power supply circuit as in claim 1,
wherein only a single DC isolating transmission channel is used for a transmission from the secondary side to the primary side of the switched-mode converter.

4. The switched-mode power supply circuit as claimed in claim 1, wherein the transformer has a primary winding and a semiconductor switch coupled thereto, wherein the semiconductor switch is designed to switch a current flowing through the primary winding on and off as stipulated by the switching signal.

5. The switched-mode power supply circuit as claimed in claim 4, wherein all of the circuit components arranged on the secondary side circuit of the switched-mode converter are DC isolated from the primary winding.

6. The switched-mode power supply circuit as in claim 1, wherein one of the two or more feedback signals is produced by an overvoltage detector circuit, wherein the feedback signal produced by the overvoltage detector circuit indicates whether or not the output voltage exceeds a prescribable threshold value.

7. The switched-mode power supply circuit as in claim 1, wherein one of the two or more feedback signals is produced by a mode selection circuit operable to receive commands from an external unit and to take the information contained in the received commands as a basis for producing a feedback signal.

8. The switched-mode power supply circuit as in claim 7, wherein the external unit is the load connected to the output voltage and in which the information contained in the received command relates to the level of the output voltage.

9. The switched-mode power supply circuit as in claim 1, wherein one of the two or more feedback signals is a wakeup signal that is produced by a wakeup detector circuit operable to use the output voltage as a basis for producing the wakeup signal.

10. The switched-mode power supply circuit as in claim 1, wherein one of the two or more feedback signals is an overtemperature signal that is produced by an overtemperature detector circuit operable to signal an overtemperature.

11. The switched-mode power supply circuit as in claim 1, wherein the modulator circuit is operable to modulate the encoded signal by means of frequency shift keying (FSK).

12. The switched-mode power supply circuit as in claim 9, wherein the encoding circuit produces a multibit digital signal as the encoded signal, in which the multibit digital signal includes information contained in the two or more feedback signals, and wherein the modulator circuit changes over a frequency of the modulated feedback signal as stipulated by the multibit digital signal.

13. The switched-mode power supply circuit as in claim 1, wherein the modulator circuit is operable to modulate the encoded signal by means of pulse width modulation (FSK).

14. The switched-mode power supply circuit as in claim 13, wherein the encoding circuit produces a duty cycle signal as the encoded signal, in which duty cycle signal includes the information contained in the two or more feedback signals, and wherein the modulator circuit is operable to adjust a duty cycle of the modulated feedback signal as stipulated by the duty cycle signal.

15. The switched-mode power supply circuit as in claim 14, wherein the DC isolating transmission channel comprises an optocoupler that is used to transmit the modulated feedback signal from the secondary side circuit to the primary side circuit of the switched-mode converter.

16. The switched-mode power supply circuit as in claim 1, wherein the DC isolating transmission channel comprises a capacitor coupled to the secondary circuit of the transformer, so that the modulated feedback signal is transmitted to the primary side circuit via the transformer.

17. The switched-mode power supply circuit as in claim 16, wherein the modulator circuit is operable to modulate the encoded signal such that the modulated feedback signal is then used to transmit after the current through a secondary of the transformer has dropped to zero.

18. A method for controlling a switched-mode power supply circuit that has a transformer having a primary winding and a secondary winding to isolate a primary side circuit from a secondary side circuit; the method comprising:
producing a switching signal by a control circuit on the primary side circuit of the switched-mode converter;
switching of a primary current flowing through the primary winding on and off as stipulated by the switching signal in order to convert an input voltage into an output voltage;
producing an encoded signal by encoding two or more feedback signals on the secondary side circuit of the switched-mode converter;
producing a single modulated feedback signal by modulating the encoded signal on the secondary side circuit of the switched-mode converter;
transmitting the modulated feedback signal to the control circuit on the primary side circuit using a DC isolating transmission channel.

19. The method as in claim 18, wherein the modulation of the encoded signal prompts pulse width modulation or frequency shift keying (FSK).

20. The method as in claim 18, wherein the modulated feedback signal is transmitted using an optocoupler.

21. The method as in claim 18, wherein the modulated feedback signal is a current signal that is supplied to the primary circuit via a capacitor and is transmitted to the primary side circuit of the switched-mode converter via the transformer.
